(19) United States
(12) Patent Application Publication
(10) Pub. No.: US 2024/0211419 A1
(43) Pub. Date: Jun. 27, 2024

(54) METHOD OF PROCESSING COMPUTATION AND INFORMATION PROCESSING APPARATUS

(71) Applicant: Fujitsu Limited, Kawasaki-shi (JP)

(72) Inventor: Yutaka TAMIYA, Yokohama (JP)

(73) Assignee: Fujitsu Limited, Kawasaki-shi (JP)

(21) Appl. No.: 18/480,532

(22) Filed: Oct. 4, 2023

(30) Foreign Application Priority Data
Dec. 23, 2022 (JP) 2022-206358

(51) Int. Cl. G06F 13/16; G06F 17/16

(52) U.S. Cl. CPC G06F 13/1673; G06F 17/16

(57) ABSTRACT

A non-transitory computer-readable recording medium stores a program that causes a computer to execute a process of calculating a two-electron integral obtained by executing computing for a plurality of times of iterations, the process includes computing, in a first time of the iterations, with a value stored in a first buffer as an input value, outputting a result of the computing in the first time of the iterations to a second buffer, computing, in a second time of the iterations, with a value stored in the second buffer as an input value, updating the value stored in the first buffer by outputting a result of the computing in the second time of the iterations to the first buffer, and computing, in a third time of the iterations, with the updated value stored in the first buffer as an input value.

### CROSS-REFERENCE TO RELATED APPLICATION

This application is based upon and claims the benefit of priority of the prior Japanese Patent Application No. 2022-206358, filed on Dec. 23, 2022, the entire contents of which are incorporated herein by reference.

### FIELD

The embodiment discussed herein is related to a method of processing computation and an information processing apparatus.

### BACKGROUND

An interaction calculation (two-electron integral) of an electron pair is known to be very heavy in a density functional method that is usual in quantum chemical simulation. In a case where a basis function of a two-electron particle is represented by a Gaussian-type integral (see expression (1)), efficient calculation may be performed by using an Obara-Saika algorithm. In the Obara-Saika algorithm, the two-electron integral that accounts for most of the amount of calculation is represented by a recurrence formula (see expression (2)). Thus, calculation may be efficiently performed. Here, aₓ, a_{y}, and a_{z} indicated in expression (1) and a in expression (2) are represented by the relationship of a=aₓ+a_{y}+a_{z} (a is an integer greater than or equal to zero). Here, “a” means angular momentum. Also, angular momentums b, c, and d in expression (2) are related in a similar manner to the case of the angular momentum a.

$$Gaussian - type function {φ}_{α}^{A} = {( x - {A}_{x} )}^{{a}_{x}} {( y - {A}_{y} )}^{{a}_{y}} {( z - {A}_{z} )}^{{a}_{z}} {e}^{- α {\vert r - A \vert}^{2}} \qquad ( 1 )$$

$${( a + {1}_{i} b \vert cd )}^{( m )} = {( PA )}_{i} {( ab \vert cd )}^{( m )} + {( WP )}_{i} {( ab \vert cd )}^{( m + 1 )} + \frac{{a}_{i}}{2 ζ} [ {( a - {1}_{i} b \vert cd )}^{( m )} - \frac{ρ}{ζ} {( a - {1}_{i} b \vert cd )}^{( m + 1 )} ] + \frac{- i}{2 ζ} [ {( a b - {1}_{i} \vert cd )}^{( m )} - \frac{ρ}{ζ} {( a b - {1}_{i} \vert cd )}^{( m + 1 )} ] + \frac{{c}_{i}}{2 ( ζ + η )} {( ab \vert c - {1}_{i} d )}^{( m + 1 )} + \frac{{d}_{i}}{2 ( ζ + η )} {( ab \vert c d - {1}_{i} )}^{( m + 1 )} \qquad ( 2 )$$

$$a , b , c , d , m : integer greater than or equal to zero \\ ρ , ζ , η : constant$$

For example, according to the Obara-Saika algorithm, (ab|cd)^{(m)} is recursively obtained by using a value list of (00|00)^{(m′)} as an initial value. Here, (ab|cd)=(ab|cd)⁽⁰⁾ is a value of the two-electron integral.

FIG. 6 is a diagram illustrating calculation of a two-electron integral using the Obara-Saika algorithm. As illustrated in FIG. 6, a vector v(a+1, b, c, d) corresponding to (a+1 b|cd) may be calculated by a vector v(a, b, c, d) corresponding to (ab|cd), v(a−1, b, c, d) corresponding to (a−1 b|cd), v(a, b−1, c, d) corresponding to (a b−1|cd), v(a, b, c−1, d) corresponding to (ab|c−1 d), and v(a, b, c, d−1) corresponding to (ab|c d−1).

In quantum mechanics, the bra-ket notation is known as a notation for describing quantum states. When limited to “bra” out of “bra” and “ket”, an expansion of the bra indices (a, b) is a two-dimensional recurrence formula for the bra indices a and b. FIG. 7 is a diagram illustrating the expansion of the bra indices. As illustrated in FIG. 7, target values may be calculated by alternately applying two types of expansions in the bra indices a and b. For example, as the a expansion, a calculation v(a+1, b) in the +1 direction of the index a may be calculated from v(a−1, b), v(a, b), and v(a, b−1). As the b expansion, v(a, b+1) in the +1 direction of the index b may be calculated from v(a−1, b), v(a, b), and v(a, b−1). The values of the target v(5, 5) may be calculated by alternately applying the a expansion and the b expansion. The number of pieces of intermediate data (intermediate points) for obtaining target data is at most 2×N (N: the maximum indices of a and b). Hatched circles in FIG. 7 are intermediate data (intermediate points).

FIG. 8 is a diagram illustrating the expansion of bra indices and ket indices. As illustrated in FIG. 8, when the expansion of the bra indices (a, b) is executed at each intermediate point of the expansion of the ket indices (c, d), two sets of two-dimensional expansions are combined together, and a four-dimensional recurrence formula may be calculated.

A technique is disclosed in which, in two-electron integral, in a case where values of the two-electron integral are computed, the values of the two-electron integral are stored in a buffer region such that the priority given to the storing of a value of the two-electron integral corresponding to a basis function becomes higher as a calculation load of this basis function increases.

Japanese Laid-open Patent Publication No. 2005-202855 is disclosed as related art.

Obara S. and Saika A., “Efficient recursive computation of molecular integrals over Cartesian Gaussian functions”, Journal of Chemical Physics, vol. 84, No. 7, pp. 3963-3974, April 1986 is also disclosed as related art.

### SUMMARY

According to an aspect of the embodiment, a non-transitory computer-readable recording medium stores a program that causes a computer to execute a process of calculating a two-electron integral obtained by executing computing for a plurality of times of iterations, the process includes computing, in a first time of the iterations, with a value stored in a first buffer as an input value, outputting a result of the computing in the first time of the iterations to a second buffer as a computing result in the first time of the iterations, computing, in a second time of the iterations immediately after the first time of the iterations, with a value stored in the second buffer, which has been output as the result of the computing in the first time of the iterations, as an input value, updating the value stored in the first buffer by outputting a result of the computing in the second time of the iterations to the first buffer as a computing result in the second time of the iterations, and computing, in a third time of the iterations immediately after the second time of the iterations, with the updated value stored in the first buffer as an input value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of an information processing apparatus according to an embodiment;

FIG. 2 is a diagram illustrating an example of buffer groups according to the embodiment;

FIG. 3 is a diagram illustrating an example of a computation process according to the embodiment;

FIG. 4A is a diagram (1) illustrating an example of a flowchart of a computation process according to the embodiment;

FIG. 4B is a diagram (2) illustrating an example of a flowchart of a computation process according to the embodiment;

FIG. 4C is a diagram (3) illustrating an example of a flowchart of a computation process according to the embodiment;

FIG. 5 is a diagram illustrating an example of a computer that executes a computation processing program;

FIG. 6 is a diagram illustrating calculation of a two-electron integral by using the Obara-Saika algorithm;

FIG. 7 is a diagram illustrating an expansion of bra indices; and

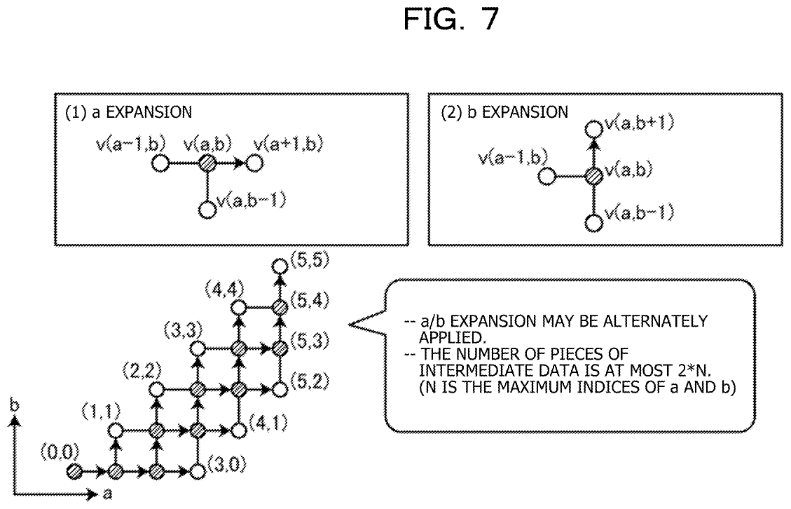

FIG. 8 is a diagram illustrating the expansion of bra indices and ket indices.

### DESCRIPTION OF EMBODIMENT

In the calculation of the two-electron integral by using the Obara-Saika algorithm, all the calculated values of the two-electron integral are stored in the buffer. This causes a problem in that the amount of memory increases. For example, calculation results of the two-electron integral that executes the expansion in the bra indices (a, b) are stored in the buffer at each intermediate point of the expansion in the ket indices (c, d). Thus, the amount of memory increases.

An embodiment of a method of processing computation and an information processing apparatus disclosed herein will be described in detail below with reference to the drawings. The present disclosure is not limited to the embodiment.

### [Functional Configuration of Information Processing Apparatus]

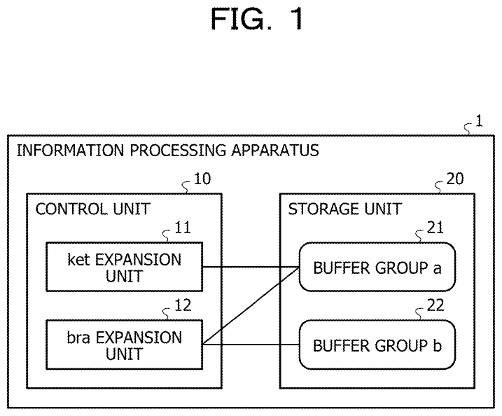

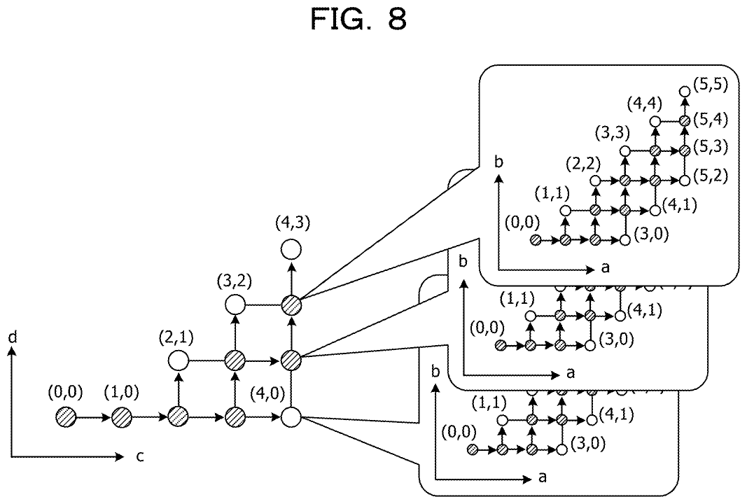

FIG. 1 is a diagram illustrating a functional configuration of the information processing apparatus according to the embodiment. An information processing apparatus 1 illustrated in FIG. 1 calculates a four-dimensional recurrence formula by executing a bra index expansion at each intermediate point of a ket index expansion (see FIG. 8) in calculation of two-electron integral calculation obtained by executing a recurrence formula calculation related to four-dimensional indices. In so doing, during the ket index expansion, the information processing apparatus 1 manages a buffer group for the bra index expansion as a double buffer, thereby holding values of a desired minimum number of intermediate points (intermediate values). The recurrence formula calculation herein means, for example, recurrence formula calculation by using the Obara-Saika algorithm and is represented by Expression (2). According to the Obara-Saika algorithm, (ab|cd)^{(m)} is recursively obtained by using a value list of (00|00)^{(m′)} as the initial values. An intermediate values of two-electron integral are (ab|cd). Here, (a, b) indicates bra indices, and (c, d) indicates ket indices. Hereinafter, description will be given with (a, b) as the bra indices and (c, d) as the ket indices.

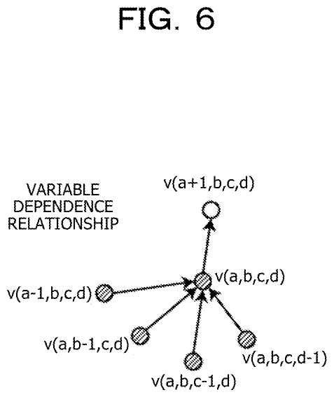

A diagram representing the calculation of the two-electron integral using the Obara-Saika algorithm is illustrated in FIG. 6. A vector v(a+1, b, c, d) corresponding to (a+1 b|cd) may be calculated by a recurrence formula using values of five intermediate points including a vector v(a, b, c, d) corresponding to (ab|cd), a vector v(a−1, b, c, d) corresponding to (a−1 b|cd), a vector v(a, b−1, c, d) corresponding to (a b−1|cd), a vector v(a, b, c−1, d) corresponding to (ab|c−1 d), and a vector v(a, b, c, d−1) corresponding to (ab|c d−1).

As illustrated in FIG. 1, the information processing apparatus 1 includes a control unit 10 and a storage unit 20. The control unit 10 includes a ket expansion unit 11 and a bra expansion unit 12. The storage unit 20 includes a buffer group a 21 and a buffer group b 22.

The buffer group a 21 and the buffer group b 22 are buffer groups used for a bra expansion.

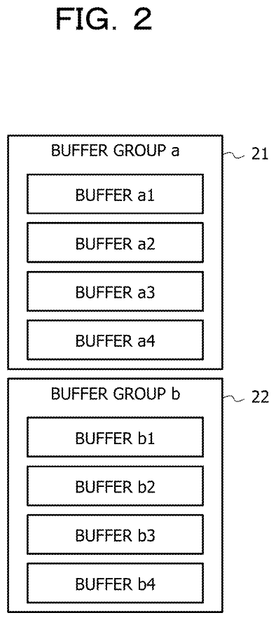

An example of buffer groups will be described with reference to FIG. 2. FIG. 2 is a diagram illustrating an example of the buffer groups according to the embodiment. Buffer groups include the buffer group a 21 and the buffer group b 22. The buffer group a 21 and the buffer group b 22 are switched between the input and the output, step by step in a ket expansion.

The buffer group a 21 and the buffer group b 22 each include four buffers. For example, the buffer group a 21 includes four buffers, a buffer a1 to a buffer a4. The buffer group b 22 includes four buffers, a buffer b1 to a buffer b4. For example, when the step of the ket expansion is c=2, the values of the intermediate points of c=1 indicating an immediately previous step are respectively stored in the buffers a1 to a4. The values of intermediate points of c=2 are computed by using the buffers a1 to a4, and computation results are respectively stored in the buffers b1 to b4. In a case of c=3 indicating the next step out of the steps of the ket expansion, values of intermediate points of c=3 are respectively computed by using the buffer b1 to the buffer b4, and computation results are caused to overwrite the buffer a1 to the buffer a4, respectively.

Referring back to FIG. 1, the ket expansion unit 11 executes the expansion for the ket indices (c, d). For example, the ket expansion unit 11 switches the buffer groups between the input and the output, step by step in the ket expansion (each time c is incremented). The ket expansion unit 11 executes the bra expansion at each intermediate point of the ket index (c, d) expansion in the current step. The bra expansion unit 12 to be described later performs the bra expansion.

The bra expansion unit 12 executes a two-dimensional bra expansion for the indices (a, b) by using the buffer group switched to the input as input and the buffer group switched to the output as output. For example, based on the switching between the input and output by the ket expansion unit 11, the bra expansion unit 12 alternately performs a bra expansion step with the buffer group a 21 as the input and the buffer group b 22 as the output, and a bra expansion step with the buffer group b 22 as the input and the buffer group a 21 as the output.

### [Example of Computation Process]

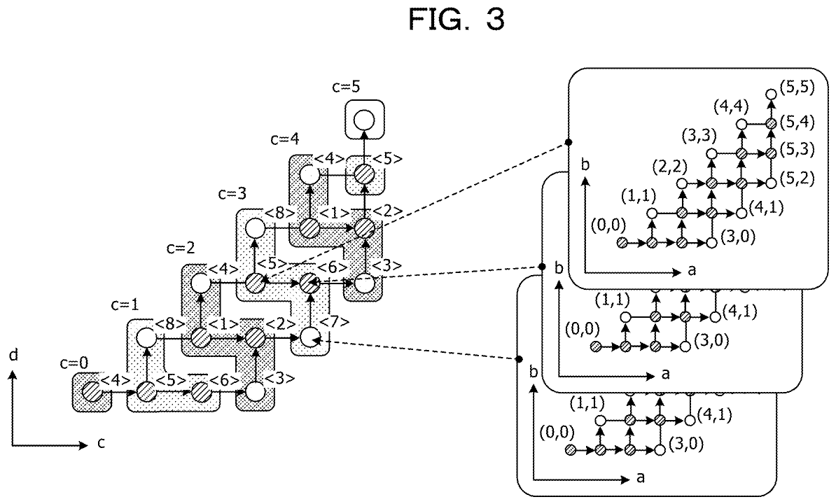

An example of a computation process according to the embodiment is described with reference to FIG. 3. FIG. 3 is a diagram illustrating an example of the computation process according to the embodiment. Referring to FIG. 3, a computation process in which the bra index (a, b) expansion is executed at each intermediate point of the ket index (c, d) expansion is illustrated. Here, <1>, <2>, <3>, and <4> are storage positions associated with the positions of the intermediate points of the ket expansion (c, d), indicating storage positions in the buffer group a (the buffers a1, a2, a3, and a4), and <5>, <6>, <7>, and <8> are storage positions associated with the positions of the intermediate points of the ket expansion (c, d), indicating the storage positions in the buffer group b (the buffers b1, b2, b3, b4).

As an example, the computation process in an iteration of c=3 indicating the step of the ket expansion is described.

First, in the computation in the iteration of c=3 indicating a step of the ket expansion, the ket expansion unit 11 switches the buffer groups between the input and output such that the buffer group a is set to the input and the buffer group b is set to the output. Here, <1>, <2>, <3>, and <4> correspond to the buffers a1, a2, a3, and a4 in the buffer group a for the input. Intermediate values of points of all combinations of (a, b) calculated by the bra expansion at the positions (c, d) of the intermediate points of the ket expansion are stored in <1>, <2>, <3>, and <4>. As an example, an intermediate value of the points v(i, j, c=2, d=1) ((i, j) indicates combinations of all (a, b) calculated by the bra expansion) is stored in <1>. Also, <5>, <6>, <7>, and <8> correspond to the buffers b1, b2, b3, and b4 in the buffer group b for the output.

In such a status, the bra expansion unit 12 executes the bra expansion with the buffer group a as the input and the buffer group b as the output. The bra expansion unit 12 inputs the buffer group a, calculates values of the intermediate points corresponding to <5> to <8> of c=3, and outputs calculation results to the buffer group b.

The bra expansion unit 12 executes the bra expansion for the intermediate points corresponding to <5> and <7> of c=3 as follows. For the intermediate point corresponding to <5> of c=3, the bra expansion unit 12 calculates the bra expansion with <1> to <3> of c=2 as the input of the recurrence formula. Also for the intermediate point corresponding to <7> of c=3, the bra expansion unit 12 calculates the bra expansion with <1> to <3> of c=2 as the input of the recurrence formula.

Next, the bra expansion unit 12 executes the bra expansion for the intermediate points corresponding to <6> and <8> of c=3 as follows. For the intermediate point corresponding to <6> of c=3, the bra expansion unit 12 calculates the bra expansion with <2> and <4> of c=2 and <5> of c=3 as the input of the recurrence formula. Also for the intermediate point corresponding to <8> of c=3, the bra expansion unit 12 calculates the bra expansion with <2> and <4> of c=2 and <5> of c=3 as the input of the recurrence formula.

In this way, the bra expansion unit 12 calculates the values of <5> to <8> of c=3 and stores calculation results in the buffer group b. For example, the bra expansion unit 12 stores the value of <5> in the b1 of the buffer group b. The bra expansion unit 12 stores the value of <6> in the b2 of the buffer group b. The bra expansion unit 12 stores the value of <7> in the b3 of the buffer group b. The bra expansion unit 12 stores the value of <8> in the b4 of the buffer group b.

Next, in the computation in an iteration of c=4 indicating the step of the ket expansion, the ket expansion unit 11 switches the buffer groups between the input and output such that the buffer group b is set to the input and the buffer group a is set to the output. Here, <5>, <6>, <7>, and <8> correspond to the buffers b1, b2, b3, and b4 in the buffer group b for the input. Intermediate values of points of all combinations of (a, b) calculated by the bra expansion at the positions (c, d) of the intermediate points of the ket expansion are stored in <5>, <6>, <7>, and <8>. As an example, an intermediate value of the points v(i, j, c=4, d=2) ((i, j) indicates combinations of all (a, b) calculated by the bra expansion) is stored in <6>. Also, <1>, <2>, <3>, and <4> correspond to the buffers a1, a2, a3, and a4 in the buffer group a for the output.

In such a status, the bra expansion unit 12 executes the bra expansion with the buffer group b as the input and the buffer group a as the output. The bra expansion unit 12 inputs the buffer group b, calculates values of the intermediate points corresponding to <1> to <4> of c=4, and updates the buffer group a with calculation results.

Calculation for obtaining, for example, <6> of c=3 is described with reference to the diagram of FIG. 6. By referring to <2>=v(a, b, c, d−1), <4>=v(a, b, c−1, d), and <5>=v(a, b, c, d), and further referring to v(a−1, b, c, d) and v(a, b−1, c, d) in the bra expansion, <6>=v(a, b, c+1, d) is calculated. For example, the bra expansion unit 12 calculates a recurrence formula that uses five intermediate values to calculate a value of an intermediate point corresponding to <6>=v(a, b, c+1, d).

Thus, the information processing apparatus 1 may calculate the two-electron integral value of an arbitrary index combination (ab|cd) only with the double buffer (buffer group a 21 and buffer group b 22) including four buffers for the input and four buffers for the output as the buffer for the bra expansion. In other words, when calculating, for example, the intermediate points corresponding to the buffer group b 22 in c=3, the information processing apparatus 1 inputs only the values of the intermediate points stored in the buffer group a 21 in c=2 without use of any of the values of the intermediate points stored in c=1. Thus, the amount of memory desired for the calculation of two-electron integral may be suppressed. Furthermore, when calculating, for example, the intermediate points corresponding to the buffer group b 22 in c=3, the information processing apparatus 1 uses, as the input, only the values of the intermediate points stored in the buffer group a 21 in c=2 and outputs the calculation results to the buffer group b 22, so that the roles of the buffer groups are completely separated into an input-only buffer group and an output-only buffer group. The separation of the buffer groups into the input-only buffer group and the output-only buffer group desirably works for improving the performance of a memory model of a central processing unit (CPU) or dedicated hardware. For example, by using the double buffer, the information processing apparatus 1 may suppress the amount of memory desired for the calculation of the two-electron integral, and further, may improve the performance.

### [Flowcharts of Computation Process]

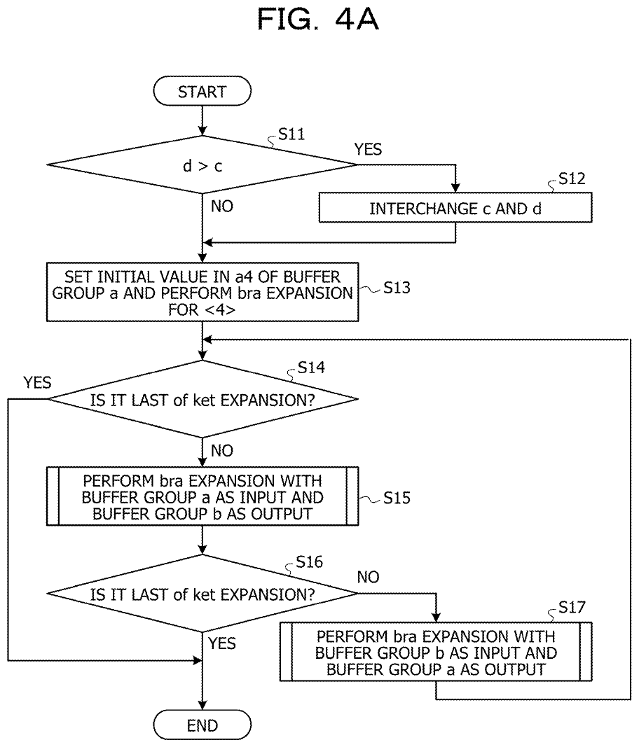

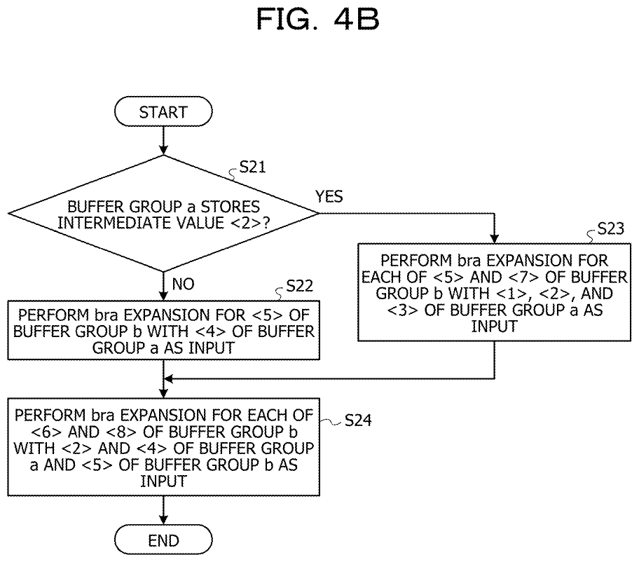

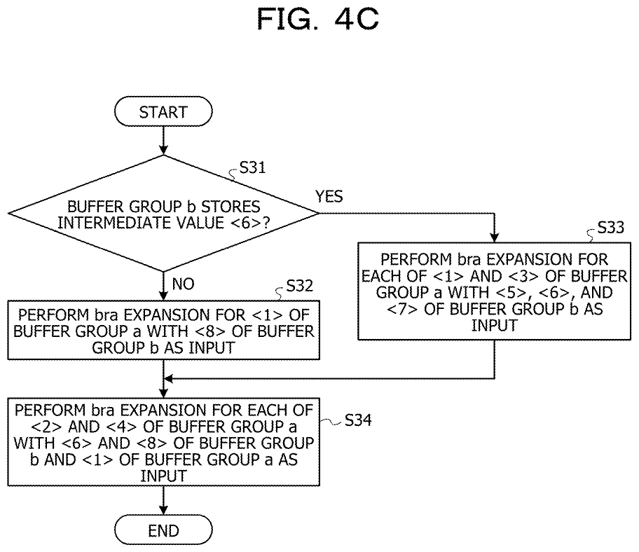

FIGS. 4A to 4C are diagrams illustrating examples of flowcharts of the computation process according to the embodiment. For FIGS. 4A to 4C, description is given with the indices of the ket expansion as (c, d) and the indices of the bra expansion as (a, b). Also in FIGS. 4A to 4C, <1>, <2>, <3>, and <4> are storage positions associated with the positions of the intermediate points of the ket expansion (c, d), indicating storage positions (the buffers a1, a2, a3, and a4) in the buffer group a, and <5>, <6>, <7>, and <8> are storage positions associated with the positions of the intermediate points of the ket expansion (c, d), indicating storage positions (the buffers b1, b2, b3, b4) in the buffer group b.

As illustrated in FIG. 4A, for the index of the ket expansion, the information processing apparatus 1 determines whether d is greater than c (step S11). In a case where the information processing apparatus 1 determines that d is greater than c (step S11; Yes), since the indices c and d are interchangeable in the two-electron integral, the information processing apparatus 1 interchanges c and d to convert c to be greater than or equal to d (step S12). The information processing apparatus 1 proceeds to step S13.

In contrast, in a case where the information processing apparatus 1 determines that d is not greater than c (step S11; No), the information processing apparatus 1 proceeds to step S13. The information processing apparatus 1 sets an initial value to the buffer a4 in the buffer group a 21 and performs the bra expansion for <4> (step S13). For example, the information processing apparatus 1 calculates the bra expansion for the intermediate point corresponding to <4> of c=0.

The information processing apparatus 1 determines whether it is the last of the ket expansion (step S14). For example, the information processing apparatus 1 increments the index c indicating the step of the ket expansion. The information processing apparatus 1 determines whether it is the last of the ket expansion by using the index c. In the case of the ket expansion illustrated in FIG. 3, it is sufficient that the information processing apparatus 1 determine whether the index c is greater than 5. In a case where the information processing apparatus 1 determines that it is not the last of the ket expansion (step S14; No), the information processing apparatus 1 performs the bra expansion with the buffer group a 21 as the input and the buffer group b 22 as the output (step S15). A process of performing the bra expansion with the buffer group a 21 as the input and the buffer group b 22 as the output will be described later.

The information processing apparatus 1 determines whether it is the last of the ket expansion (step S16). For example, the information processing apparatus 1 increments the index c indicating the step of the ket expansion. The information processing apparatus 1 determines whether it is the last of the ket expansion by using the index c. In a case where the information processing apparatus 1 determines that it is not the last of the ket expansion (step S16; No), the information processing apparatus 1 performs the bra expansion with the buffer group b 22 as the input and the buffer group a 21 as the output (step S17). A process of performing the bra expansion with the buffer group b 22 as the input and the buffer group a 21 as the output will be described later. The information processing apparatus 1 proceeds to step S14.

In contrast, in a case where the information processing apparatus 1 determines it is the last of the ket expansion (step S14; Yes or step S16; Yes), the information processing apparatus 1 ends the computation process.

Referring to FIG. 4B, a process of performing the bra expansion with the buffer group a 21 as the input and the buffer group b 22 as the output is described. The process corresponds to the case of the computation process in the index of c=1, c=3, or c=5 in FIG. 3.

The information processing apparatus 1 determines whether the intermediate value <2> is stored in the buffer group a 21 (step S21). For example, the information processing apparatus 1 determines whether the value of the intermediate point corresponding to <2> is stored in a buffer a2 of the buffer group a 21.

In a case where the information processing apparatus 1 determines that the intermediate value <2> is not stored in the buffer group a 21 (step S21; No), the information processing apparatus 1 performs the bra expansion for <5> of the buffer group b 22 with <4> of the buffer group a 21 as the input (step S22). For example, in <5> of c=1 illustrated in FIG. 3, the information processing apparatus 1 performs the bra expansion for <5> of c=1 with <4> of c=0 as the input of the recurrence formula. As a result, an intermediate value of the point v(i, j, c=1, d=0) is obtained. Here, (i, j) represents all the combinations of (a, b) calculated by the bra expansion. The information processing apparatus 1 proceeds to step S24.

In contrast, in a case where the information processing apparatus 1 determines that the intermediate value <2> is provided in the buffer group a 21 (step S21; Yes), the information processing apparatus 1 performs the bra expansion for each of <5> and <7> of the buffer group b 22 with <1>, <2>, and <3> of the buffer group a 21 as the input (step S23). For example, in <5> and <7> of c=3 illustrated in FIG. 3, the information processing apparatus 1 performs the bra expansion for <5> and <7> with <1>, <2>, and <3> of c=2 as the input of the recurrence formula. As a result, an intermediate value of the point v(i, j, c=3, d=2) is obtained. Also, an intermediate value of the point v(i, j, c=4, d=1) is obtained. Here, (i, j) represents all the combinations of (a, b) calculated in the bra expansion. The information processing apparatus 1 proceeds to step S24.

In step S24, the information processing apparatus 1 performs the bra expansion for each of <6> and <8> of the buffer group b 22 with <2> and <4> of the buffer group a 21 and <5> of the buffer group b 22 as the input. For example, in <6> and <8> of c=3 illustrated in FIG. 3, the information processing apparatus 1 performs the bra expansion for <6> and <8> with <2> and <4> of c=2 and <5> of c=3 as the input of the recurrence formula. As a result, an intermediate value of the point v(i, j, c=4, d=2) is obtained. Also, an intermediate value of the point v(i, j, c=3, d=3) is obtained. Here, (i, j) represents all the combinations of (a, b) calculated by the bra expansion. In <6> and <8> of c=1 illustrated in FIG. 3, the information processing apparatus 1 performs the bra expansion for <6> and <8> with <2> and <4> of c=0 and <5> of c=1 as the input of the recurrence formula. At this time, an initial value is set for <2> of c=0. The information processing apparatus 1 ends the process to perform the bra expansion with the buffer group a 21 as the input and the buffer group b 22 as the output.

Referring to FIG. 4C, a process of performing the bra expansion with the buffer group b 22 as the input and the buffer group a 21 as the output is described. The process corresponds to the case of the computation process in the index of c=2 or c=4 in FIG. 3.

The information processing apparatus 1 determines whether the intermediate value <6> is stored in the buffer group b 22 (step S31). For example, the information processing apparatus 1 determines whether the value of the intermediate point corresponding to <6> is provided in a buffer b2 of the buffer group b 22.

In a case where the information processing apparatus 1 determines that the intermediate value <6> is not stored in the buffer group b 22 (step S31; No), the information processing apparatus 1 performs the bra expansion for <1> of the buffer group a 21 with <8> of the buffer group a 21 as the input (step S32). The information processing apparatus 1 proceeds to step S34.

In contrast, in a case where the information processing apparatus 1 determines that the intermediate value <6> is stored in the buffer group b 22 (step S31; Yes), the information processing apparatus 1 performs the bra expansion for each of <1> and <3> of the buffer group a 21 with <5>, <6>, and <7> of the buffer group b 22 as the input (step S33). For example, in <1> and <3> of c=4 illustrated in FIG. 3, the information processing apparatus 1 performs the bra expansion for <1> and <3> with <5>, <6>, and <7> of c=3 as the input of the recurrence formula. As a result, an intermediate value of the point v(i, j, c=4, d=3) is obtained. Also, an intermediate value of the point v(i, j, c=5, d=2) is obtained. Here, (i, j) represents all the combinations of (a, b) calculated by the bra expansion. In <1> and <3> of c=2 illustrated in FIG. 3, the information processing apparatus 1 performs the bra expansion for <1> and <3> with <5>, <6>, and <7> of c=1 as the input of the recurrence formula. At this time, an initial value is set for <7> of c=1. The information processing apparatus 1 proceeds to step S34.

In step S34, the information processing apparatus 1 performs the bra expansion for each of <2> and <4> of the buffer group a 21 with <6> and <8> of the buffer group b 22 and <1> of the buffer group a 21 as the input (step S34). For example, in <2> and <4> of c=4 illustrated in FIG. 3, the information processing apparatus 1 performs the bra expansion for <2> and <4> with <6> and <8> of c=3 and <1> of c=4 as the input of the recurrence formula. As a result, an intermediate value of the point v(i, j, c=5, d=3) is obtained. Also, an intermediate value of the point v(i, j, c=4, d=4) is obtained. Here, (i, j) represents all the combinations of (a, b) calculated by the bra expansion. The information processing apparatus 1 ends the process of performing the bra expansion with the buffer group b 22 as the input and the buffer group a 21 as the output.

### Effects of Embodiment

According to the above-described embodiment, the information processing apparatus 1 executes calculation of a two-electron integral obtained by executing computing for a plurality of times of iterations as follows. In computing in a first time of the iterations, the information processing apparatus 1 computes with a value stored in a first buffer as an input value and outputs a result of the computing to a second buffer as a computing result in the first time of the iterations. In computing in a second time of the iterations immediately after the first time of the iterations, the information processing apparatus 1 computes with a value stored in the second buffer, which has been output as the result of the computing in the first time of the iterations, as an input value and updates the value stored in the first buffer by outputting a result of the computing to the first buffer as a computing result in the second time of the iterations. The information processing apparatus 1 computes, in a third time of the iterations immediately after the second time of the iterations, by using the updated value stored in the first buffer as an input value. With the above-described configuration, the information processing apparatus 1 may suppress the amount of memory desired for the calculation of the two-electron integral.

According to the above-described embodiment, preferably, in the computing in the first time of the iterations, the information processing apparatus 1 uses, as input values, values of a predetermined number of intermediate points indicative of computing results of computing in a previous time of the iterations stored in the first buffer to calculate the two-electron integral of the predetermined number of the intermediate points and outputs a result of the calculation to the second buffer. Preferably, in the computing in the second time of the iterations, the information processing apparatus 1 uses, as input values, the values of the predetermined number of the intermediate points stored in the second buffer to calculate the two-electron integral of the predetermined number of the intermediate points in the second time of the iterations and updates the values stored in the first buffer by outputting a result of the calculating to the first buffer. With the above-described configuration, in the computing in each time of the iterations, the information processing apparatus 1 inputs only the values of the intermediate points stored in the buffer storing the computation result of the computation in the previous time of the iterations without use of any of the values of the intermediate points in an iteration earlier than the previous time of the iterations. As a result, the information processing apparatus 1 completely separates the roles of the buffers into an input-only buffer and an output-only buffer. Thus, the performance of a memory model of, for example, the CPU or the dedicated hardware may be improved. Also, the information processing apparatus 1 may suppress the amount of memory desired for the calculation of the two-electron integral.

According to the above-described embodiment, preferably, the information processing apparatus 1 switches input and output between the first buffer and the second buffer every time the iterations change. Thus, the information processing apparatus 1 may execute the calculation of the two-electron integral obtained by executing the computing for a plurality of times of iterations by using the double buffer.

### [Others]

The illustrated elements of the information processing apparatus 1 are not necessarily desired to be physically configured as illustrated in the drawings. For example, the specific form of distribution or integration of the information processing apparatus 1 is not limited to that illustrated in the drawings, and all or part thereof may be configured to be functionally or physically distributed or integrated in arbitrary units depending on various loads, usage states, and so forth. For example, the ket expansion unit 11 and the bra expansion unit 12 may be integrated into a single one unit. The ket expansion unit 11 may be separated into a processing unit that performs the ket expansion and a processing unit that switches the buffer groups for each step of the ket expansion. The storage unit 20 may be coupled, to the information processing apparatus 1, as an external device outside the information processing apparatus 1 via a network.

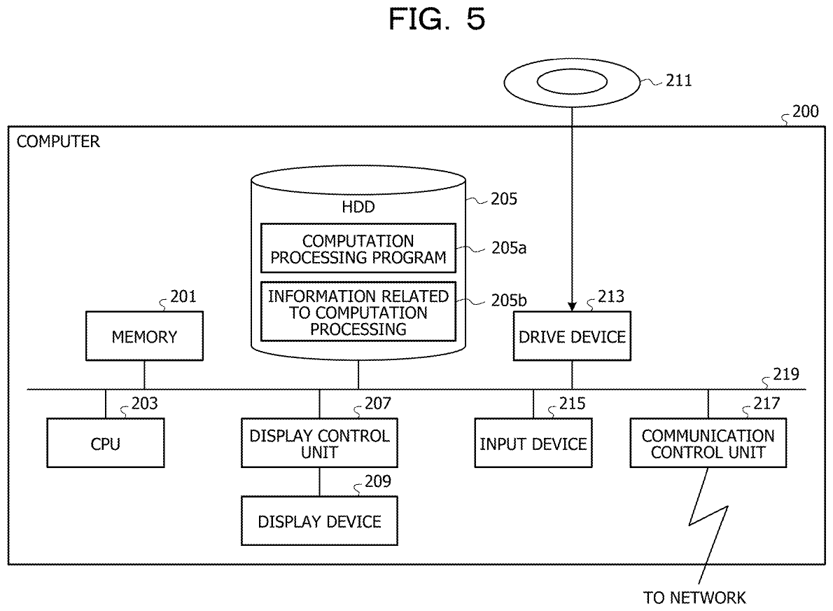

The various types of processes described according to the above embodiment may be implemented by executing, with a computer such as a personal computer or a workstation, a program prepared in advance. Hereinafter, an example of the computer that executes a computation processing program that implements functions similar to those of the computation process of the information processing apparatus 1 illustrated in FIG. 1 is described. FIG. 5 is a diagram illustrating an example of the computer that executes the computation processing program.

As illustrated in FIG. 5, a computer 200 includes a CPU 203 that executes various types of computation processes, an input device 215 that accepts input of data from a user, and a display control unit 207 that controls a display device 209. The computer 200 also includes a drive device 213 that reads the program and the like from a storage medium and a communication control unit 217 that exchanges data with another computer via a network. The computer 200 also includes a memory 201 that temporarily stores various types of information and a hard disk drive (HDD) 205. The memory 201, the CPU 203, the HDD 205, the display control unit 207, the drive device 213, the input device 215, and the communication control unit 217 are coupled to each other via a bus 219.

The drive device 213 is, for example, a device for a removable disk 211. The HDD 205 stores a computation processing program 205a and information related to computation processing 205b.

The CPU 203 reads the computation processing program 205a, loads the computation processing program 205a onto the memory 201, and executes the computation processing program 205a as processes. Such processes correspond to functional units of the information processing apparatus 1. The information related to computation processing 205b corresponds to the buffer group a 21 and the buffer group b 22. For example, the removable disk 211 stores various types of information such as the computation processing program 205a.

The computation processing program 205a is not necessarily stored in the HDD 205 from the beginning. For example, the computation processing program 205a is stored in a “portable physical medium” to be inserted into the computer 200 such as a flexible disk (FD), a compact disk read-only memory (CD-ROM), a Digital Versatile Disk (DVD), a magneto-optical disk, or an integrated circuit (IC) card. The computer 200 may execute the computation processing program 205a by reading the computation processing program 205a from the portable physical medium.

The computation process performed by the information processing apparatus 1 described according to the above embodiment may be applied to, for example, a simulation for drug discovery or material development. For example, the computation process performed by the information processing apparatus 1 may be applied to generating a new drug by solving a quantum mechanics equation or performing a simulation on what is desirable for an ammonia catalyst.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program that causes a computer to execute a process of calculating a two-electron integral obtained by executing computing for a plurality of times of iterations, the process comprising:
computing, in a first time of the iterations, with a value stored in a first buffer as an input value;
outputting a result of the computing in the first time of the iterations to a second buffer as a computing result in the first time of the iterations;
computing, in a second time of the iterations immediately after the first time of the iterations, with a value stored in the second buffer, which has been output as the result of the computing in the first time of the iterations, as an input value;
updating the value stored in the first buffer by outputting a result of the computing in the second time of the iterations to the first buffer as a computing result in the second time of the iterations; and
computing, in a third time of the iterations immediately after the second time of the iterations, with the updated value stored in the first buffer as an input value.

2. The non-transitory computer-readable recording medium according to claim 1, the process further comprising:
calculating, in the computing in the first time of the iterations, the two-electron integral of a predetermined number of intermediate points with values of the predetermined number of intermediate points stored in the first buffer, which are indicative of computing results of computing in a previous time of the iterations, as input values;
outputting, to the second buffer, a result of calculating the two-electron integral of the predetermined number of the intermediate points in the computing in the first time of the iterations;
calculating, in the computing in the second time of the iterations, the two-electron integral of the predetermined number of intermediate points with values of the predetermined number of intermediate points stored in the second buffer as input values; and
updating the values stored in the first buffer by outputting, to the first buffer, a result of calculating the two-electron integral of the predetermined number of the intermediate points in the computing in the second time of the iterations.

3. The non-transitory computer-readable recording medium according to claim 1, the process further comprising:
switching input and output between the first buffer and the second buffer every time the iterations change.

4. A method of processing computation, comprising:
computing by a computer, in a first time of a plurality of times of iterations of computing for calculating a two-electron integral, with a value stored in a first buffer as an input value;
outputting a result of the computing in the first time of the iterations to a second buffer as a computing result in the first time of the iterations;
computing, in a second time of the iterations immediately after the first time of the iterations, with a value stored in the second buffer, which has been output as the result of the computing in the first time of the iterations, as an input value;
updating the value stored in the first buffer by outputting a result of the computing in the second time of the iterations to the first buffer as a computing result in the second time of the iterations; and
computing, in a third time of the iterations immediately after the second time of the iterations, with the updated value stored in the first buffer as an input value.

5. An information processing apparatus, comprising:
a memory; and
a processor coupled to the memory and the processor configured to:
compute, in a first time of a plurality of times of iterations of computing for calculating a two-electron integral, with a value stored in a first buffer as an input value;
output a result of the computing in the first time of the iterations to a second buffer as a computing result in the first time of the iterations;
compute, in a second time of the iterations immediately after the first time of the iterations, with a value stored in the second buffer, which has been output as the result of the computing in the first time of the iterations, as an input value;
update the value stored in the first buffer by outputting a result of the computing in the second time of the iterations to the first buffer as a computing result in the second time of the iterations; and
compute, in a third time of the iterations immediately after the second time of the iterations, with the updated value stored in the first buffer as an input value.
